(19) United States
(12) Patent Application Publication
(10) Pub. No.: US 2015/0341651 A1
(43) Pub. Date: Nov. 26, 2015

(54) JPEG FILE FORMAT BASED ENCODING AND DECODING METHOD IN MOBILE APPARATUS AND DEVICE THEREOF

(71) Applicant: SAMSUNG ELECTRONICS CO., LTD., SUWON-SI (KR)

(72) Inventor: SHAOBO ZHU, SUZHOU CITY (CN)

(21) Appl. No.: 14/712,660

(22) Filed: May 14, 2015

(30) Foreign Application Priority Data
May 21, 2014 (CN) 201410216259.X

(51) Int. Cl. H04N 19/46; H04N 19/44; H04L 9/08; H04N 19/124

(52) U.S. Cl. CPC H04N 19/46; H04N 19/124; H04N 19/44; H04L 9/0819; H04L 2209/24; H04L 2209/34

(57) ABSTRACT

A JPEG file format based encoding and decoding method and device in a mobile apparatus are provided. The encoding method includes: encoding a data of a source image by means of a private encoding table, to produce a compressed data of the source image; encrypting a unique identification of the mobile apparatus, to produce an attribute code data of the mobile apparatus; generating an encoded image data including the compressed data and the attribute code data of the mobile apparatus, wherein the private encoding table is stored in the mobile apparatus. The methods may efficiently prevent from an illegal propagation and viewing of a file without increased system overhead, protecting personal privacy of a user.

### CROSS-REFERENCE TO RELATED APPLICATION

This application claims priority from Chinese Patent Application No. 201410216259.X filed on May 21, 2014 in the Chinese Intellectual Property Office, and all the benefits accruing therefrom under 35 U.S.C. 119, the disclosure of which is incorporated herein by reference in its entirety.

### BACKGROUND

1. Field

The present disclosure relates to file encoding and decoding, and more particularly, to a JPEG file format based encoding and decoding method and device in a mobile apparatus.

2. Description of the Related Art

With the development of image processing technologies, there have been many methods for image processing. The existing JPEG (Joint Photographic Experts Group) file format is a self-contained file format including sufficient information for decoding, which can be decoded and viewed in any application environment. This will cause a problem with privacy in file. Once a file is leaked, it will be propagated and viewed without any limit.

For this reason, an image encoding and decoding method with improved privacy are required.

### SUMMARY

The present disclosure aims at solving the technical problems described above. Accordingly, an aspect of the present disclosure provides a JPEG file format based encoding and decoding method and device in a mobile apparatus.

In order to accomplish the above objects, there is provided a JPEG file format based encoding method in a mobile apparatus, including: encoding a data of a source image by means of a private encoding table, to produce a compressed data of the source image; encrypting a unique identification of the mobile apparatus, to produce an attribute code data of the mobile apparatus; and generating an encoded image data including the compressed data and the attribute code data of the mobile apparatus, wherein the private encoding table is stored in the mobile apparatus.

Preferably, the private encoding table may include a quantization table and a Huffman table.

Preferably, encrypting the unique identification of the mobile apparatus may include encrypting the unique identification of the mobile apparatus by means of a predetermined encryption algorithm.

Preferably, the encoding method may further include generating a file header including the attribute code data of the mobile apparatus, wherein the file header does not include the private encoding table.

In order to accomplish the above objects, there is provided a JPEG file format based decoding method in a mobile apparatus, including: parsing an encoded image data including a compressed data and an attribute code data of the mobile apparatus; comparing the attribute code data of the mobile apparatus parsed from the encoded image data with an attribute code data of the mobile apparatus itself; and decoding the encoded image data by means of the private encoding table stored in the mobile apparatus when the attribute code data of the mobile apparatus parsed from the encoded image data is the same as the attribute code data of the mobile apparatus itself.

Preferably, the private encoding table may include a quantization table and a Huffman table.

Preferably, the decoding method may further include encrypting a unique identification of the mobile apparatus by means of a predetermined encryption algorithm, to produce the attribute code data of the mobile apparatus itself.

Preferably, parsing the encoded image data may include parsing a file header of the encoded image data, wherein the file header includes the attribute code data of the mobile apparatus.

In order to accomplish the above objects, there is provided a JPEG file format based encoding device in a mobile apparatus, including: an encoding unit to encode a data of a source image by means of a private encoding table, producing a compressed data of the source image, wherein the private encoding table is stored in the mobile apparatus and includes a quantization table and a Huffman table; an encryption unit to encrypt a unique identification of the mobile apparatus by means of a predetermined encryption algorithm, producing an attribute code data of the mobile apparatus, and to send the attribute code data to a data packing unit; the data packing unit to generate an encoded image data including the compressed data from the encoding unit and the attribute code data of the mobile apparatus from the encryption unit; and a file header generation unit to generate a file header including the attribute code data of the mobile apparatus, wherein the file header does not include the private encoding table.

In order to accomplish the above objects, there is provided a JPEG file format based decoding device in a mobile apparatus, including: a parsing unit to parse an encoded image data including a compressed data and an attribute code data of the mobile apparatus, and to parse a file header of the encoded image data, wherein the file header includes the attribute code data of the mobile apparatus; an encryption unit to encrypt a unique identification of the mobile apparatus by means of a predetermined encryption algorithm, producing the attribute code data of the mobile apparatus itself; a comparison unit to compare the attribute code data of the mobile apparatus parsed from the encoded image data with the attribute code data of the mobile apparatus itself; and a decoding unit to decode the encoded image data by means of the private encoding table stored in the mobile apparatus when the attribute code data of the mobile apparatus parsed from the encoded image data is the same as the attribute code data of the mobile apparatus itself, wherein the private encoding table includes a quantization table and a Huffman table.

The above mentioned JPEG file format based encoding and decoding method and device encrypt the source data by storing the private encoding table in the mobile apparatus rather than adding it into the file header, and adding the attribute code into the file header, so as to achieve an authentication. The mentioned encoding and decoding methods and devices may efficiently prevent from an illegal propagation and viewing of a file without increased system overhead, protecting personal privacy of a user.

### BRIEF DESCRIPTION OF THE DRAWINGS

The above and other features and advantages of the present inventive concept will become more apparent by describing in detail example embodiments thereof with reference to the attached drawings in which:

The above and/or other objects and features of the present disclosure will become more apparent from the following descriptions of the exemplary embodiments of the present disclosure, taken in conjunction with the accompanying drawings, in which:

FIG. 1 is a flow diagram of a JPEG file format based encoding method in a mobile apparatus according to the first exemplary embodiment of the present disclosure;

FIG. 2 is a flow diagram of a JPEG file format based encoding method in a mobile apparatus according to the second exemplary embodiment of the present disclosure;

FIG. 3 is a diagram illustrating file headers of the JPEG file;

FIG. 4 is a flow diagram of a JPEG file format based decoding method in a mobile apparatus according to the third exemplary embodiment of the present disclosure;

FIG. 5 is a flow diagram of a JPEG file format based decoding method in a mobile apparatus according to the fourth exemplary embodiment of the present disclosure;

FIG. 6 is a block diagram of a JPEG file format based encoding device in a mobile apparatus according to the fifth exemplary embodiment of the present disclosure;

FIG. 7 is a block diagram of a JPEG file format based encoding device in a mobile apparatus according to the sixth exemplary embodiment of the present disclosure;

FIG. 8 is a block diagram of a JPEG file format based decoding device in a mobile apparatus according to the seventh exemplary embodiment of the present disclosure; and

FIG. 9 is a block diagram of a JPEG file format based decoding device in a mobile apparatus according to the eighth exemplary embodiment of the present disclosure.

### DETAILED DESCRIPTION OF THE EMBODIMENTS

In conjunction with the particular embodiments of the present invention, a JPEG file format based encoding and decoding method in a mobile apparatus of the disclosure will be described in detail with reference to the accompanying drawings.

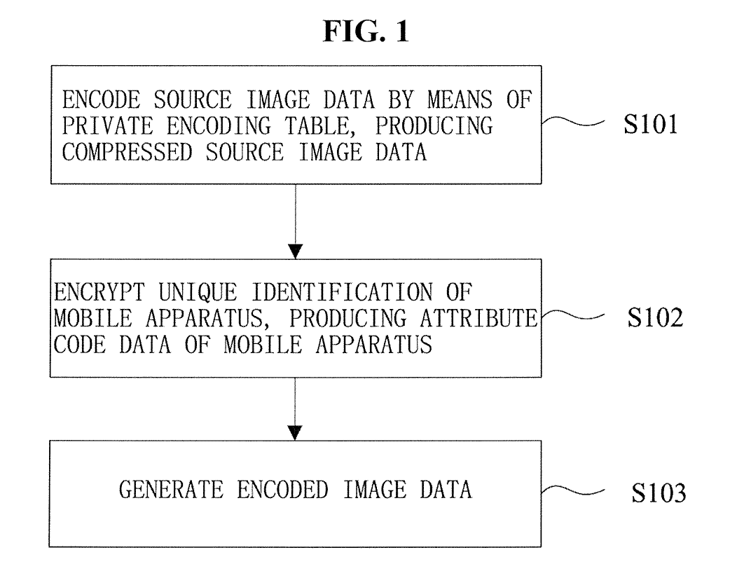

FIG. 1 is a flow diagram of a JPEG file format based encoding method in a mobile apparatus according to the first exemplary embodiment of the present disclosure.

At step S101, a data of a source image is encoded by means of a private encoding table, producing a compressed data of the source image.

At step S102, a unique identification of the mobile apparatus is encrypted, producing an attribute code data of the mobile apparatus.

At step S103, an encoded image data including the compressed data and the attribute code data of the mobile apparatus is generated. The private encoding table is stored in the mobile apparatus.

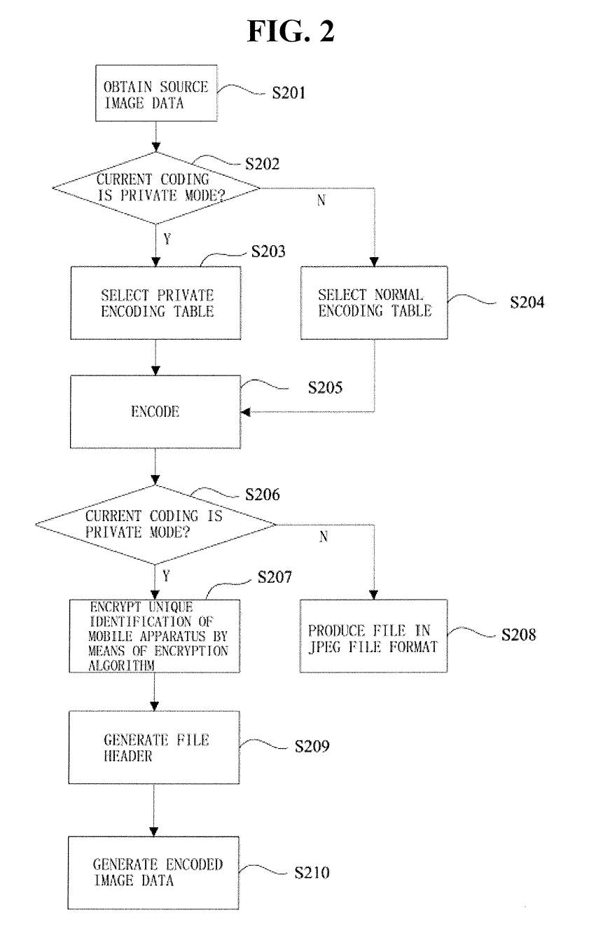

FIG. 2 is a flow diagram of a JPEG file format based encoding method in a mobile apparatus according to the second exemplary embodiment of the present disclosure.

At step S201, a data of a source image is obtained.

At step S202, it is determined that whether a current coding is a private mode according to user's requirement.

If it is not a private mode, a normal encoding table, for example, a default encoding table in the mobile apparatus is selected at step S204. The normal encoding table may include a quantization table and a Huffman table. Then the data of the source image is encoded by means of the normal encoding table at step S205.

If it is a private mode, a private encoding table is selected at step S203. Then at step S205, the data of the source image is encoded by means of the private encoding table, producing a compressed data of the source image. The private encoding table may include a quantization table and a Huffman table. Besides, the private encoding table is fixed in the mobile apparatus, and cannot be changed by other applications on the mobile apparatus.

Here, it should be understood that the normal and private encoding table are named differently because they are utilized in different modes, although both of them include the quantization table and the Huffman table, that is, the content contained therein are the same.

At step S206, it is determined that whether the current encoding is the private mode once more. If not, a file in JPEG file format is produced at step S208.

If it is a private mode, a unique identification of the mobile apparatus is encrypted by means of a predetermined encryption algorithm, for example, by means of a Cyclical Redundancy Check (CRC)32 encryption algorithm, producing an attribute code data at step S207.

Further, the encryption algorithm is preferably an irreversible encryption algorithm. This is because that when the encryption algorithm is a reversible or crackable encryption algorithm, the safety will be reduced and it could be cracked with ease. Therefore, an irreversible encryption algorithm, for example, the CRC32 provides higher safety.

At step S209, a file header is generated. In particularly, the file header contains the attribute code data and information other than the private encoding table in the JPEG file format. It should be understood that the file header generated at step S209 may corresponds to a file header produced by deleting the encoding table from the JPEG file format and then adding the attribute code data into the file header.

Finally, an encoded image data including the compressed image data and the file header is generated at step S210.

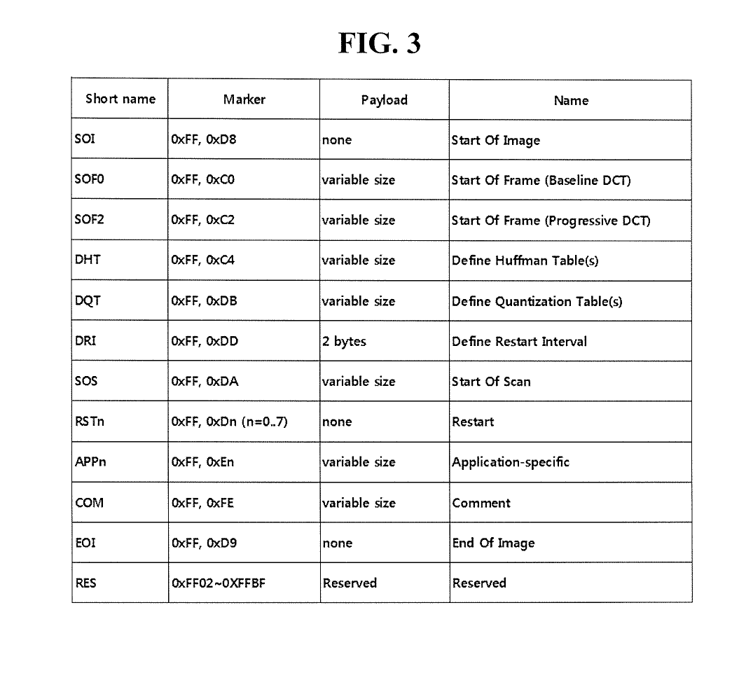

Further, uniqueness is necessary for the unique identification of the mobile apparatus. That is, the unique identification, for example, a device serial number may uniquely identify the mobile apparatus. The attribute code data includes information on a device serial number implicitly. The identification header of the information may be elected from reserved bits in a definition of the JPEG file identification header. FIG. 3 is a diagram illustrating file headers of the JPEG file. As illustrated in FIG. 3, the 0xFF02 through 0xFFBF on the last row in FIG. 3 are the reserved bits. The information may use, for example, 0xFFB0 in the range of the reserved bits as the identification header thereof.

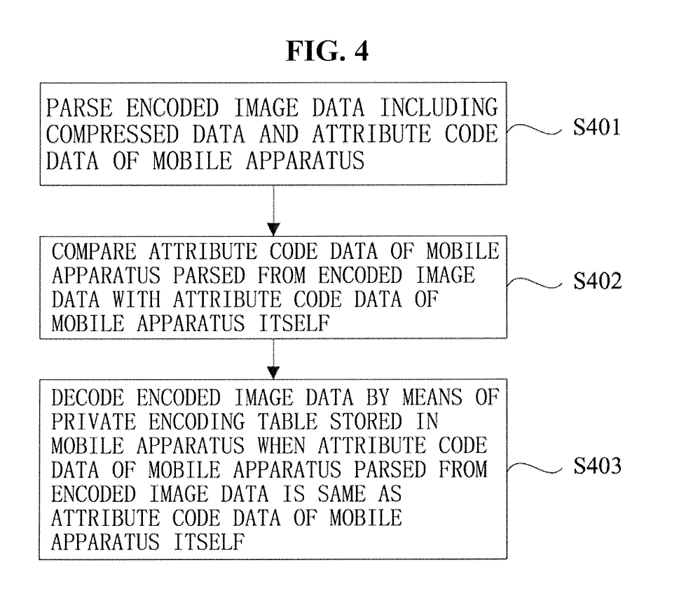

FIG. 4 is a flow diagram of a JPEG file format based decoding method in a mobile apparatus according to the third exemplary embodiment of the present disclosure.

At step S401, an encoded image data including a compressed data and an attribute code data of the mobile apparatus is parsed.

At step S402, the attribute code data of the mobile apparatus parsed from the encoded image data is compared with an attribute code data of the mobile apparatus itself.

At step S403, when the attribute code data of the mobile apparatus parsed from the encoded image data is the same as the attribute code data of the mobile apparatus itself, the encoded image data may be decoded by means of a private encoding table stored in the mobile apparatus.

In particularly, the private encoding table may include the quantization table and the Huffman table.

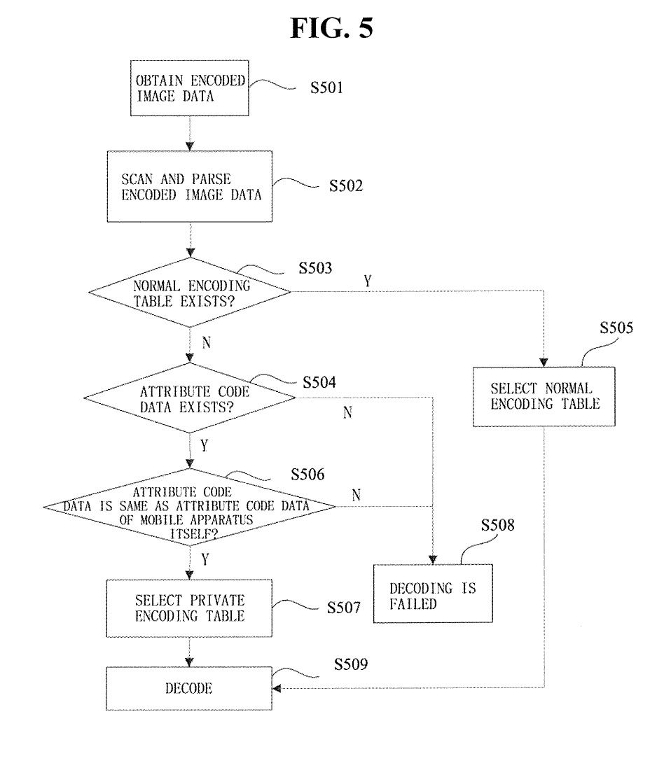

FIG. 5 is a flow diagram of a JPEG file format based decoding method in a mobile apparatus according to the fourth exemplary embodiment of the present disclosure.

At step S501, the mobile apparatus obtains an encoded image data.

At step S502, the mobile apparatus scans and parses the encoded image data.

At step S503, it is determined whether there is any normal encoding table in a file header by parsing the file header (generally, the identification header in the file header) in the encoded image data. If there is a normal encoding table, the normal encoding table is selected at step S505. Then the encoded file is decoded at step S509.

If there is no normal encoding table in the file header parsed from the encoded image data, it is determined that whether there is any attribute code data in the file header at step S504. The attribute code data is a data produced by encrypting a unique identification of the mobile apparatus when performing an encoding operation to an image data to be encoded.

If it is determined that there is no attribute code data in the file header at step 504, the decoding is failed at step S508. If it is determined that there is an attribute code data in the file header, it is determined whether the attribute code data is matched with an attribute code data of the mobile apparatus itself at step 506. The attribute code data of the mobile apparatus itself is a data produced by encrypting a unique identification of the mobile apparatus. The encryption algorithm keeps consistent with an encryption algorithm of the attribute code data existing in the file header of the obtained encoded image data, for example, the CRC32 encryption algorithm is used for both situations.

If it is determined that the attribute code data is not the same as the attribute code data of the mobile apparatus itself at step S506, the decoding is failed at step S508.

If it is determined that the attribute code data is the same as the attribute code data of the mobile apparatus itself at step S506, a private encoding table is selected at step S507. Finally, the encoded image data is decoded at step S509, producing a souse image data.

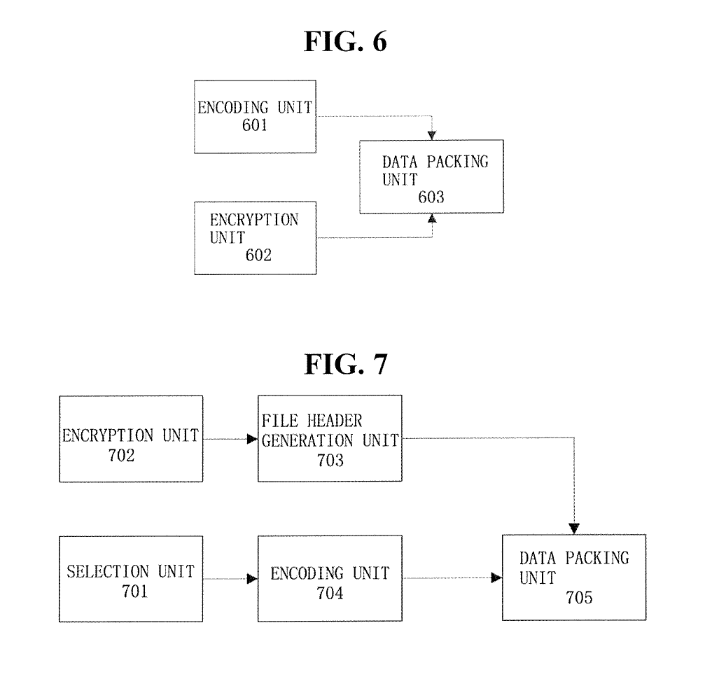

FIG. 6 is a block diagram of a JPEG file format based encoding device in a mobile apparatus according to the fifth exemplary embodiment of the present disclosure.

As illustrated in FIG. 6, the JPEG file format based encoding device in the mobile apparatus may include an encoding unit 601, an encryption unit 602 and a data packing unit 603.

The encoding unit 601 encodes a data of a source image by means of a private encoding table, producing a compressed data of the source image. Then the encoding unit 601 sends the compressed data to the data packing unit 603. The private encoding table is stored in the mobile apparatus. Further, the private encoding table includes a quantization table and a Huffman table.

The encryption unit 602 is used to encrypt a unique identification of the mobile apparatus, producing an attribute code data of the mobile apparatus. Then the encryption unit 602 sends the attribute code data to the data packing unit 603.

The data packing unit 603 is used to generate an encoded image data including the compressed data and the attribute code data of the mobile apparatus.

FIG. 7 is a block diagram of a JPEG file format based encoding device in a mobile apparatus according to the sixth exemplary embodiment of the present disclosure.

As illustrated in FIG. 7, the JPEG file format based encoding device in a mobile apparatus according to the sixth exemplary embodiment of the present disclosure may include a selection unit 701, an encryption unit 702, an file header generation unit 703, an encoding unit 704 and a data packing unit 705.

The selection unit 701 is used to select a private encoding table and send the private encoding table to the encoding unit 703. The private encoding table includes a quantization table and a Huffman table. Besides, the private encoding table is fixed in the mobile apparatus.

The encryption unit 702 is used to encrypt a unique identification of the mobile apparatus, producing an attribute code data. Then the encryption unit 702 sends the attribute code data to the file header generation unit 703. For example, the encryption unit 702 may encrypt a unique identification of the mobile apparatus by means of the CRC32 encryption algorithm.

The file header generation unit 703 is used to receive the attribute code data sent by the encryption unit 702 and generate a file header. Further, the file header contains the attribute code data and information other than the private encoding table in the JPEG file format. Then the file header generation unit 703 sends the file header to the data packing unit 705.

The encoding unit 704 encodes a data of a source image by means of the private encoding table, producing a compressed data of the source image. Then the encoding unit 704 sends the compressed data to the data packing unit 705.

The data packing unit 705 is used to receive the compressed data sent by the encoding unit 704 and the file header sent by the file header generation unit 703, producing an encoded image data including the compressed image data and the file header.

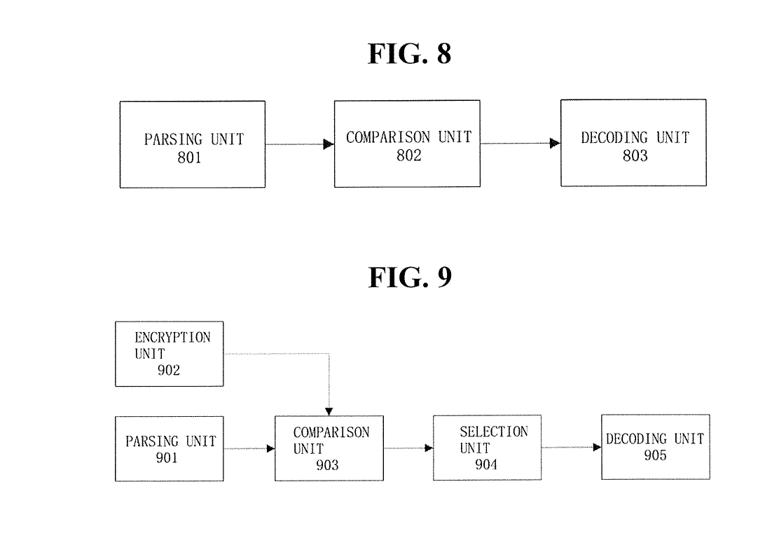

FIG. 8 is a block diagram of a JPEG file format based decoding device in a mobile apparatus according to the seventh exemplary embodiment of the present disclosure.

As illustrated in FIG. 8, the JPEG file format based decoding device in a mobile apparatus according to the seventh exemplary embodiment of the present disclosure may include a parsing unit 801, a comparison unit 802 and a decoding unit 803.

The parsing unit 801 is used to parse an encoded image data including a compressed data and an attribute code data of the mobile apparatus. Then the parsing unit 801 sends the parsed encoded image data to the comparison unit 802.

The comparison unit 802 receives the encoded image data sent by the parsing unit 801, and compare the attribute code data of the mobile apparatus parsed from the encoded image data with an attribute code data of the mobile apparatus itself.

When the attribute code data of the mobile apparatus parsed from the encoded image data is the same as the attribute code data of the mobile apparatus itself, the decoding unit 803 decodes the encoded image data by means of the private encoding table stored in the mobile apparatus, producing a decoded data of the source image. The private encoding table includes a quantization table and a Huffman table, and is fixed in the mobile apparatus.

FIG. 9 is a block diagram of a JPEG file format based decoding device in a mobile apparatus according to the eighth exemplary embodiment of the present disclosure.

As illustrated in FIG. 9, the JPEG file format based decoding device in a mobile apparatus according to the eighth exemplary embodiment of the present disclosure may include a parsing unit 901, an encryption unit 902, a comparison unit 903, a selection unit 904 and a decoding unit 905.

The parsing unit 901 is used to obtain an encoded image data including a compressed data and a file header. An attribute code data is contained in the file header. Then the parsing unit 901 scans and parses the file header. When a particular identification header is detected in the file header, the parsing unit 901 sends the attribute code data in the file header to the comparison unit 903.

The encryption unit 902 is used to encrypt a unique identification of the mobile apparatus, producing a mobile apparatus attribute code data. Then the encryption unit 902 sends the mobile apparatus attribute code data to the comparison unit 903. For example, the encryption unit 902 may perform a Cyclical Redundancy Check (CRC)32 on a unique identification of the mobile apparatus, producing the attribute code data of the mobile apparatus itself.

The comparison unit 903 is used to compare the attribute code data sent by the parsing unit 901 with the mobile apparatus attribute code data sent by the encryption unit 902. If they are same, the comparison unit 903 sends successful comparison information to the selection unit 904.

When the successful comparison information sent by the comparison unit is received, the selection unit 904 sends a private encoding table to the decoding unit 905. The private encoding table includes a quantization table and a Huffman table, and is fixed in the mobile apparatus.

The decoding unit 905 is used to receive the private encoding table sent by the selection unit 904 and the encoded image data. Then the decoding unit 905 decodes the encoded image data by means of the private encoding table, producing a decoded data of a source image.

It should be understood that the encryption algorithm utilized in the encoding and decoding methods of the present disclosure are the same, while the encryption algorithm utilized in the encoding and decoding devices of the present disclosure are the same as well.

It should be understood that the JPEG file format based encoding and decoding devices in the mobile apparatus according to the exemplary embodiments of the present disclosure may be implemented by either software or hardware.

It should be understood that the JPEG file format based encoding and decoding methods of the present disclosure are not limited to being based on the JPEG file format, and may be extended to various digital compression and encoding format, for example, JPEG2000, JPEG XR and lossless JPEG which comply with ITU-T.81 (ITU-T for International Telecommunication Union Telecommunication Standardization Sector) standard.

It should be understood that the JPEG file format based encoding devices in the mobile apparatus according to the exemplary embodiments of the present disclosure may perform the JPEG file format based encoding methods described above referring to FIGS. 1 to 3, while the JPEG file format based decoding devices in the mobile apparatus according to the exemplary embodiments of the present disclosure may perform the JPEG file format based decoding methods described above referring to FIGS. 4 and 5, which will be omitted herein to avoid repetition.

The JPEG file format based encoding and decoding methods and devices in the mobile apparatus mentioned above encrypt the source data by storing the private encoding table in the mobile apparatus rather than adding it into the file header, and adding the attribute code into the file header, so as to achieve an authentication. The mentioned encoding and decoding methods and devices may efficiently prevent from an illegal propagation and viewing of a file without increased system overhead, protecting personal privacy of a user.

While the present disclosure has been described in conjunction with the detailed description of the exemplary embodiments, the present disclosure is not limited thereto. Within the spirit and scope of the present disclosure, those skilled in the art may make various modifications and variations, which will fall into the scope defined by the claims.

What is claimed is:

1. A JPEG file format based encoding method in a mobile apparatus, comprising:
encoding a data of a source image by means of a private encoding table, to produce a compressed data of the source image;
encrypting a unique identification of the mobile apparatus, to produce an attribute code data of the mobile apparatus; and
generating an encoded image data including the compressed data and the attribute code data of the mobile apparatus,
wherein the private encoding table is stored in the mobile apparatus.

2. The encoding method of claim 1, wherein the private encoding table includes a quantization table and a Huffman table.

3. The encoding method of claim 1, wherein encrypting the unique identification of the mobile apparatus includes encrypting the unique identification of the mobile apparatus by means of a predetermined encryption algorithm.

4. The encoding method of claim 1 further comprises generating a file header including the attribute code data of the mobile apparatus, wherein the file header does not include the private encoding table.

5. A JPEG file format based decoding method in a mobile apparatus, comprising:
parsing an encoded image data including a compressed data and an attribute code data of the mobile apparatus;
comparing the attribute code data of the mobile apparatus parsed from the encoded image data with an attribute code data of the mobile apparatus itself; and
decoding the encoded image data by means of a private encoding table stored in the mobile apparatus when the attribute code data of the mobile apparatus parsed from the encoded image data is same as the attribute code data of the mobile apparatus itself.

6. The decoding method of claim 5, wherein the private encoding table includes a quantization table and a Huffman table.

7. The decoding method of claim 5 further comprises encrypting a unique identification of the mobile apparatus by means of a predetermined encryption algorithm, to produce the attribute code data of the mobile apparatus itself.

8. The decoding method of claim 5, wherein parsing the encoded image data includes parsing a file header of the encoded image data, wherein the file header includes the attribute code data of the mobile apparatus.

9. A JPEG file format based encoding device in a mobile apparatus, comprising:
an encoding unit to encode a data of a source image by means of a private encoding table, producing a compressed data of the source image, wherein the private encoding table is stored in the mobile apparatus and includes a quantization table and a Huffman table;
an encryption unit to encrypt a unique identification of the mobile apparatus by means of a predetermined encryption algorithm, producing an attribute code data of the mobile apparatus, and to send the attribute code data to a data packing unit;
the data packing unit to generate an encoded image data including the compressed data from the encoding unit and the attribute code data of the mobile apparatus from the encryption unit; and
a file header generation unit to generate a file header including the attribute code data of the mobile apparatus, wherein the file header does not include the private encoding table.

10. A JPEG file format based decoding device in a mobile apparatus, comprising:
a parsing unit to parse an encoded image data including a compressed data and an attribute code data of the mobile apparatus, and to parse a file header of the encoded image data, wherein the file header includes the attribute code data of the mobile apparatus;
an encryption unit to encrypt a unique identification of the mobile apparatus by means of a predetermined encryption algorithm, producing the attribute code data of the mobile apparatus itself;
a comparison unit to compare the attribute code data of the mobile apparatus parsed from the encoded image data with the attribute code data of the mobile apparatus itself; and
a decoding unit to decode the encoded image data by means of the private encoding table stored in the mobile apparatus when the attribute code data of the mobile apparatus parsed from the encoded image data is same as the attribute code data of the mobile apparatus itself, wherein the private encoding table includes a quantization table and a Huffman table.
